(19) United States
(12) Patent Application Publication
(10) Pub. No.: US 2009/0147293 A1
(43) Pub. Date: Jun. 11, 2009

(54) SYSTEM AND METHOD FOR UTILIZATION OF TRANSFERABLE SETTINGS FOR MULTIPLE DOCUMENT OUTPUT DRIVERS

(76) Inventors: Tony T. Quach, Anaheim, CA (US); Giri Natarajan, La Palma, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/950,437

(22) Filed: Dec. 5, 2007

(51) Int. Cl. G06F 3/12

(52) U.S. Cl. 358/1.15

(57) ABSTRACT

The subject application is directed to a system and method for utilization of transferable settings for multiple document output drivers. An initial document output driver associated with a document processing application and at least one document rendering device is first accessed. Next, selected document output settings associated with the initial document output driver are then received from an associated user. A save setting instruction is then received from the associated user via the initial document output driver. Responsive to the received save setting instruction, the selected document output settings are stored in an associated data storage. Thereafter, via at least a second document output driver, the saved document output settings are selectively retrieved so as to configure an output of an associated electronic document via the second document output driver.

### BACKGROUND OF THE INVENTION

The subject application is directed generally to configurable output drivers, and is particularly applicable to document output settings that are readily transferable to other output drivers.

Currently, document processing is frequently accomplished by software applications running on a hardware platform, such as a personal computer or workstation. Such document processing applications include word processing applications, drawing packages, CAD packages, photo-editing programs, scanning applications, and the like. Such applications will allow for creation or importing of electronic documents, as well as editing or other manipulation thereof.

It is generally desirable to output electronic documents to a document rendering device, such as a printer, facsimile, plotter, or the like. The myriad of available document rendering devices require electronic documents to be manipulated in particular ways to be compatible with the various hardware options that are available. This is generally accomplished via an output driver which is called by a software application when an output operation is desired. Thus, an application need only call an appropriate driver, and the driver will address any actions necessary to properly communicate an electronic document to an associated output or rendering device. Such drivers are frequently supplied by output device manufacturers which allow them to take full advantage of available output capabilities. In other instances, drivers may be supplied by the application provider itself, or otherwise be supplied by the purveyor of an underlying operating system on which an application runs.

Often, a user will have certain document output settings, such as selected document output properties, that will be used in connection with different output drivers. In such instances, a user will have to set the same or similar characteristics for each driver associated with one or more applications.

### SUMMARY OF THE INVENTION

In accordance with one embodiment of the subject application, there is provided a system and method for configurable output drivers.

Further, in accordance with one embodiment of the subject application, there is provided a system and method that is applicable to document output settings that are readily transferable to other output drivers.

Still further, in accordance with one embodiment of the subject application, there is provided a system for utilization of transferable settings for multiple document output drivers. The system comprises means adapted for accessing an initial document output driver associated with a document processing application and at least one document rendering device and means adapted for receiving, from an associated user, selected document output settings associated with the initial document output driver. The system also comprises means adapted for receiving, via the initial document output driver, a save setting instruction from the associated user and means responsive to a received save setting instruction for storing the selected document output settings to an associated data storage. The system further comprises means adapted for selectively retrieving via at least a second document output driver, from the associated data storage, saved document output settings so as to configure an output of an associated electronic document via the second document output driver.

In one embodiment of the subject application, at least one document rendering device includes a tangible document output device.

In another embodiment of the subject application, the selected document output settings are selected from a set comprising orientation, duplex, number of copies, sort parameters, hole punch parameters, stapling parameters, N-up printing parameters, media source selection, output destination selection, accounting information and palette selection.

In one embodiment of the subject application, the associated data storage is comprised of a registry of an associated operating system. In another embodiment, the associated data storage is comprised of a non-volatile data storage on a workstation associated with a document output driver. In a further embodiment, the associated data storage is comprised of a networked data storage in data communication with a workstation associated with a document output driver.

Still further, in accordance with one embodiment of the subject application, there is provided a method for utilization of transferable settings for multiple document output drivers in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for utilization of transferable settings for multiple document output drivers according to one embodiment of the subject application;

FIG. 2 is a block diagram illustrating controller hardware for use in the system for utilization of transferable settings for multiple document output drivers according to one embodiment of the subject application;

FIG. 3 is a functional diagram illustrating the controller for use in the system for utilization of transferable settings for multiple document output drivers according to one embodiment of the subject application;

FIG. 4 is a block diagram illustrating a workstation for use in the system for utilization of transferable settings for multiple document output drivers according to one embodiment of the subject application;

FIG. 5 is a block diagram illustrating a server for use in the system for utilization of transferable settings for multiple document output drivers according to one embodiment of the subject application;

FIG. 6 is a flowchart illustrating a method for utilization of transferable settings for multiple document output drivers according to one embodiment of the subject application; and

FIG. 7 is a flowchart illustrating a method for utilization of transferable settings for multiple document output drivers according to one embodiment of the subject application.

### DETAILED DESCRIPTION OF THE PREFERRED EMBODIMENT

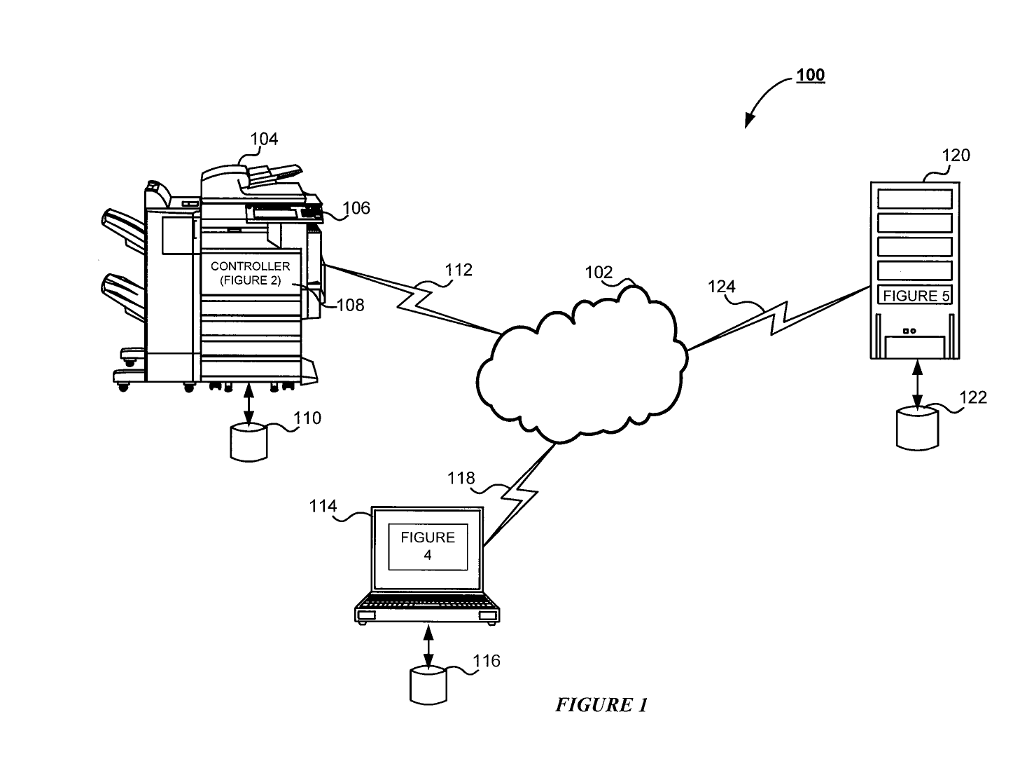

The subject application is directed to a system and method for configurable output drivers. In particular, the subject application is directed to a system and method that is applicable to document output settings that are readily transferable to other output drivers. It will become apparent to those skilled in the art that the system and method described herein are suitably adapted to a plurality of varying electronic fields employing software drivers, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for utilization of transferable settings for multiple document output drivers in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

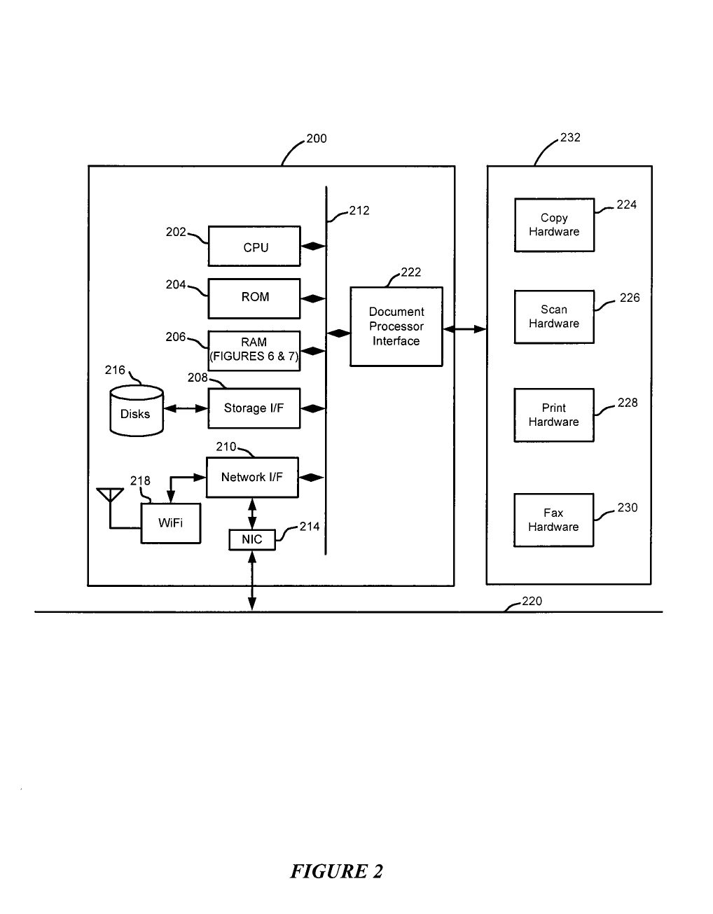

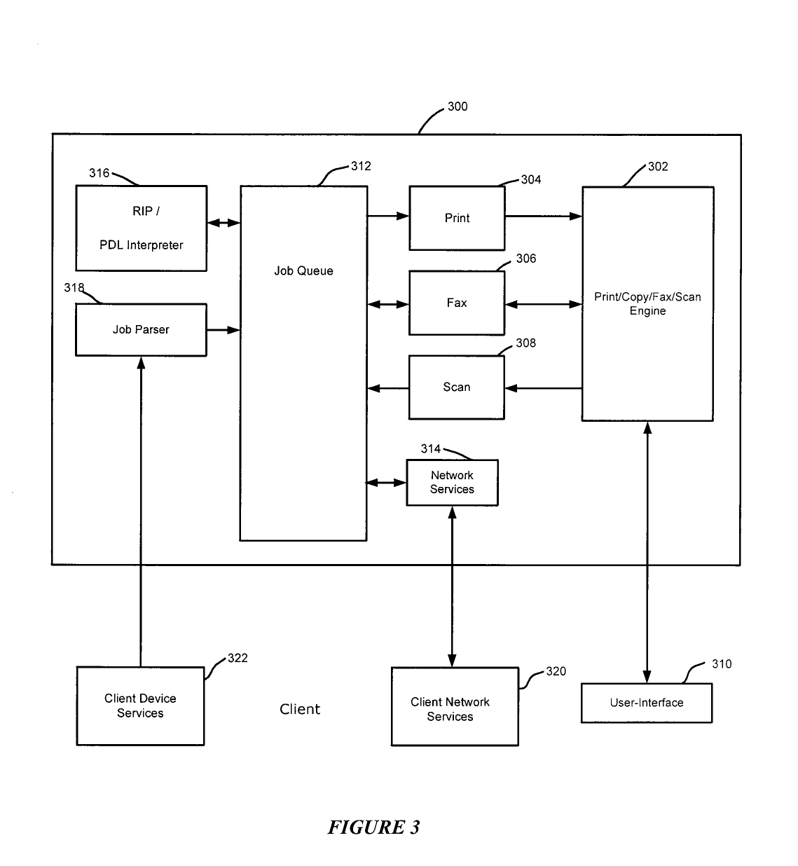

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for utilization of transferable settings for multiple document output drivers of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

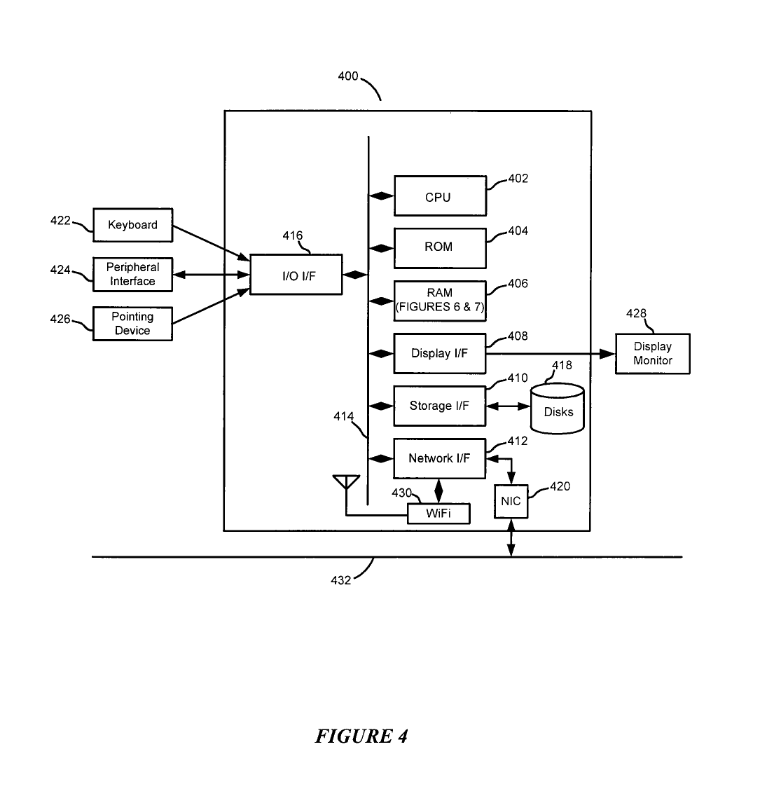

The system 100 illustrated in FIG. 1 further depicts a user device 114, in data communication with the computer network 102 via a communications link 118. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102. The functioning of the user device 114 will better be understood in conjunction with the block diagram illustrated in FIG. 4, explained in greater detail below.

Communicatively coupled to the user device 114 is a data storage device 116. In accordance with the preferred embodiment of the subject application, the data storage device 116 is any mass storage device known in the art including, for example and without limitation, magnetic storage drives, a hard disk drive, optical storage devices, flash memory devices, or any suitable combination thereof. In the preferred embodiment, the data storage device 116 is suitably adapted to store an operating system, document output drivers, applications, document data, image data, electronic database data, or the like. It will be appreciated by those skilled in the art that while illustrated in FIG. 1 as being a separate component of the system 100, the data storage device 116 is capable of being implemented as internal storage component of the user device 114, such as, for example and without limitation, an internal hard disk drive, or the like.

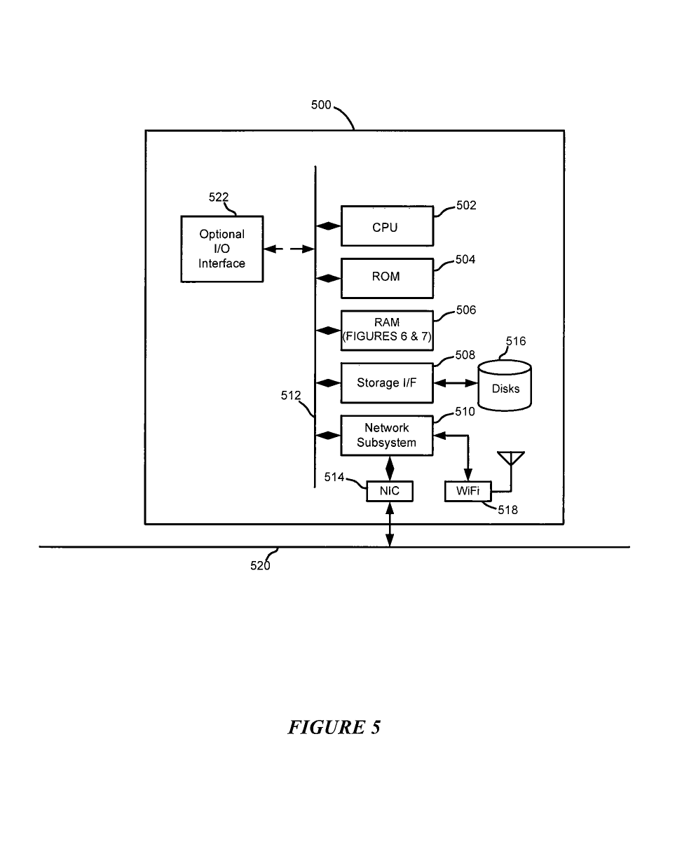

The system 100 of FIG. 1 further comprises a backend server 120 in data communication with the computer network 102 via a communications link 124. Preferably, the server 120 further includes a data storage device 122 coupled thereto. In accordance with one embodiment of the subject application, the data storage device 122 is capable of storing a plurality of databases corresponding to document processing service providers, document processing services, devices, users, payment information, and the like. The communications link 124, as will be understood by those skilled in the art, is any suitable channel of data communications known in the art including, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications. The functioning of the server 120 will better be understood in conjunction with the block diagram illustrated in FIG. 5, explained in greater detail below.

Communicatively coupled to the server 120 is a data storage device 122, suitably adapted to store user data, user preferences, document output drivers associated with user accounts, document data, applications, and the like. The skilled artisan will appreciate that the data storage device 122 is any mass storage device known in the art including, for example and without limitation, magnetic storage drives, a hard disk drive, optical storage devices, flash memory devices, or any suitable combination thereof. It will be appreciated by those skilled in the art that while illustrated in FIG. 1 as being a separate component of the system 100, the data storage device 122 is capable of being implemented as internal storage component of the server 120, such as, for example and without limitation, an internal hard disk drive, or the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 200 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the controller 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

Turning now to FIG. 4, illustrated is a hardware diagram of a suitable workstation 400, shown in FIG. 1 as the user device 114, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

Turning now to FIG. 5, illustrated is a representative architecture of a suitable server 500, shown in FIG. 1 as the server 120, on which operations of the subject system are completed. Included is a processor 502, suitably comprised of a central processor unit. However, it will be appreciated that processor 502 may advantageously be composed of multiple processors working in concert with one another as will be appreciated by one of ordinary skill in the art. Also included is a non-volatile or read only memory 504 which is advantageously used for static or fixed data or instructions, such as BIOS functions, system functions, system configuration, and other routines or data used for operation of the server 500.

Also included in the server 500 is random access memory 506, suitably formed of dynamic random access memory, static random access memory, or any other suitable, addressable memory system. Random access memory provides a storage area for data instructions associated with applications and data handling accomplished by the processor 502.

A storage interface 508 suitably provides a mechanism for volatile, bulk or long term storage of data associated with the server 500. The storage interface 508 suitably uses bulk storage, such as any suitable addressable or serial storage, such as a disk, optical, tape drive and the like as shown as 516, as well as any suitable storage medium as will be appreciated by one of ordinary skill in the art.

A network interface subsystem 510 suitably routes input and output from an associated network allowing the server 500 to communicate to other devices. The network interface subsystem 510 suitably interfaces with one or more connections with external devices to the server 500. By way of example, illustrated is at least one network interface card 514 for data communication with fixed or wired networks, such as Ethernet, token ring, and the like, and a wireless interface 518, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 520, suitably comprised of a local area network, wide area network, or a combination thereof.

Data communication between the processor 502, read only memory 504, random access memory 506, storage interface 508 and the network subsystem 510 is suitably accomplished via a bus data transfer mechanism, such as illustrated by bus 512.

Suitable executable instructions on the server 500 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 522 as will be appreciated by one of ordinary skill in the art.

In operation, an initial document output driver associated with a document processing application and at least one document rendering device is first accessed. Selected document output settings associated with the initial document output driver are then received from an associated user. A save setting instruction is then received from the associated user. In response to the receipt of the save setting instruction, the selected document output settings are stored in an associated data storage. Thereafter, via at least a second document output driver, the saved document output settings are selectively retrieved so as to configure an output of an associated electronic document via the second document output driver.

In accordance with one example embodiment of the subject application, a document processing request is initiated by a user via an application operative on the user device 114. Thereafter, a suitable document output driver associated with the application and a document processing, or rendering device 104, is initiated. It will be appreciated by those skilled in the art that suitable software applications include, for example and without limitation, word processing applications, spreadsheet applications, imaging applications, graphics applications, browsing applications, presentation applications, and the like. The skilled artisan will further appreciate that each such application on the user device 114 is capable of including one or more corresponding software drivers to facilitate the output of documents generated thereon.

Thus, upon receipt of a document processing request for the output, e.g., the facsimile transmission, printing, copying, electronic mailing, etc., of an associated electronic document, a corresponding initial document output driver is accessed on the user device 114. The user is then prompted, via a corresponding graphical user interface displayed on the user device 114, to select document output settings associated with the output of the electronic document. The skilled artisan will appreciate that suitable output settings include, for example and without limitation, orientation, duplex, number of copies, sort parameters, hole punch parameters, stapling parameters, N-up printing parameters, media source selection, output destination selection, accounting information, palette selection, and other output settings as will be known in the art.

A determination is then made whether a save instruction corresponding to the saving of document output settings has been received from the associated user. That is, whether or not the user, via the graphical user interface associated with the accessed document output driver, has selected to save the document output settings into memory. When the user has provided a save instruction, the document output settings are stored in the associated data storage device 116. It will be appreciated by those skilled in the art that the data storage device 116 is capable of containing an operating system, such as a WINDOWS-based operating system from the Microsoft Corporation, whereupon the settings are stored in the registry associated with the operating system. According to one embodiment of the subject application, the output settings are stored in a known location on the data storage device 116 such that the settings are readily accessible by the document output driver. In accordance with another embodiment of the subject application, the settings are stored in the data storage device 122 of the server 120, such that the user is able to access the settings via any user device 114 in data communication with the server 120. The skilled artisan will appreciate that such an embodiment enables the user to access saved document output driver settings from any personal electronic device coupled to the computer network 102 for output of an electronic document thereon.

A determination is then made whether or not the document output driver, via the associated graphical user interface, has received a use instruction. In accordance with one embodiment of the subject application, the use instruction corresponds to a command from the user to use document output settings previously stored on the data storage device 116. Preferably, the graphical user interface associated with the document output driver enables the user to select a given set of document output settings, or to accept the current settings, which are stored in the system registry. When the document output driver determines that the user has not elected to use previously stored output settings, the current document output driver settings are used to update the document output driver. Thereafter, the document processing request is updated in accordance with the document output driver settings. The updated document processing request is then communicated to a selected document rendering device, e.g., the document output device 104 via the computer network 102.

When the document output driver, via the graphical user interface, receives a use instruction from the associated user, the driver accesses the data storage device 116 and determines whether or not the storage location is empty. That is, the driver determines whether or not there is a registry entry corresponding to document output driver settings. The skilled artisan will appreciate that the driver is capable of ascertaining the status of the storage location on the data storage device 116, as well as the data storage device 122, dependent upon the location of the document output driver settings previously stored. When the registry entry corresponding to the document output driver settings is empty, the document output driver is updated with the current document output driver settings. Operations continue thereon with the updating of the document processing request in accordance with the output settings and communication of the request to the document rendering device 104. When the registry or storage location is not empty, the document driver output settings are retrieved from the location and used to update the document output driver. Thereafter, the document processing request is updated in accordance with the retrieved output settings and the request is communicated to the associated document rendering device 104.

It will be appreciated by those skilled in the art that the subject application is capable of adaptation for use with a plurality of different document output drivers, each of which is capable of using the stored document output driver settings. Thus, a second document output driver is capable of retrieving the document driver output settings from the data storage device 116 so as to configure the output of an associated electronic document via the second document output driver to the document rendering device 104.

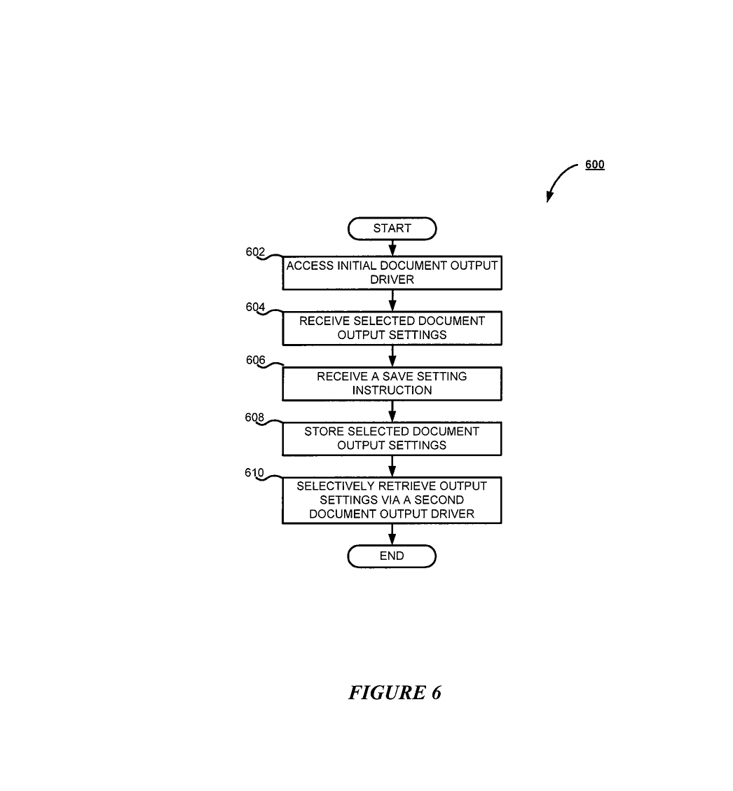

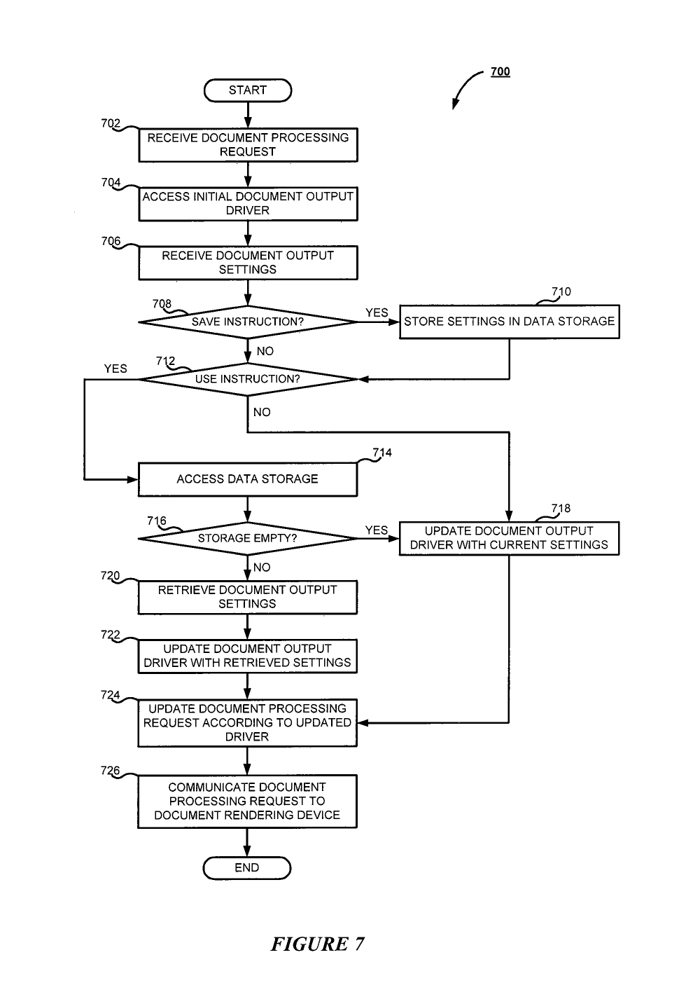

The skilled artisan will appreciate that the subject system 100 and components described above with respect to FIG. 1, FIG. 2, FIG. 3, FIG. 4, and FIG. 5, will be better understood in conjunction with the methodologies described hereinafter with respect to FIG. 6 and FIG. 7. Turning now to FIG. 6, there is shown a flowchart 600 illustrating a method for utilization of transferable settings for multiple document output drivers in accordance with one embodiment of the subject application. Beginning at step 602, an initial document output driver associated with a document processing application and at least one document rendering device 104 is first accessed on the user device 114. The skilled artisan will appreciate that suitable applications include, for example and without limitation, word processing applications, spreadsheet applications, imaging applications, graphics applications, browsing applications, presentation applications, and the like. It will further be appreciated by those skilled in the art that each such application on the user device 114 is capable of including one or more corresponding software drivers to facilitate the output of documents generated thereon At step 604, selected document output settings associated with the initial document output driver are then received from an associated user. Suitable document output settings include, for example and without limitation, orientation, duplex, number of copies, sort parameters, hole punch parameters, stapling parameters, N-up printing parameters, media source selection, output destination selection, accounting information, palette selection, and the like. At step 606, a save setting instruction is received via the document output driver from the associated user. In response to the receipt of the save setting instruction, the selected document output settings are stored at step 608, in an data storage associated with the user device 114, e.g., the data storage device 116. Flow then proceeds to step 610, whereupon the output settings are retrieved by a second document output driver so as to configure an output of an associated electronic document. That is, a second document output driver, associated with an application on the user device 114, retrieves the settings from the data storage device 116, which are used to configure the output of a given electronic document.

Referring now to FIG. 7, there is shown a flowchart 700 illustrating a method for utilization of transferable settings for multiple document output drivers in accordance with one embodiment of the subject application. The methodology depicted in FIG. 7 begins at step 702, whereupon a document processing request is received by the user device 114 from an associated user via an application operative on the user device 114. An initial document output driver is then initiated on the user device 114 in association with the application within which the document processing request originated at step 704. In accordance with one embodiment of the subject application, the document processing request includes at least one electronic document and at least one associated document processing operation, such as, for example and without limitation, printing, copying, facsimile transmission, electronic mail transmission, and the like.

At step 706, the user is prompted to select output settings associated with the output of the electronic document via a corresponding graphical user interface displayed on the user device 114. The skilled artisan will appreciate that suitable output settings include, for example and without limitation, orientation, duplex, number of copies, sort parameters, hole punch parameters, stapling parameters, N-up printing parameters, media source selection, output destination selection, accounting information, palette selection, and other output settings as will be known in the art. A determination is then made at step 708 whether a save instruction has been received from the associated user. That is, whether the document output driver has received a command from the user to save the current document output settings in associated storage.

When a save instruction has been received at step 708, flow proceeds to step 710, whereupon the document output settings are stored in the associated data storage device 116. The skilled artisan will appreciate that the user device 114 is capable of running an operating system, such as a WINDOWS-based operating system from the Microsoft Corporation, whereupon the settings are stored in the registry associated with the operating system. In accordance with one embodiment of the subject application, the output settings are stored on the data storage device 116, the data storage device 122, or other suitable networked or non-volatile storage device in data communication with the user device 114. It will be appreciated by those skilled in the art that such storage enables the user to access saved document output driver settings from any personal electronic device coupled to the computer network 102 for output of an electronic document thereon.

Flow then proceeds to step 712, whereupon a determination is made whether a use instruction has been received from the associated user via the associated graphical user interface. In accordance with one embodiment of the subject application, the use instruction corresponds to a command from the user to use document output settings previously stored on the data storage device 116. That is, the user is able, via the graphical user interface, to select a given set of document output settings, or to accept the current settings, which are stored in the system registry. When the document output driver determines, at step 712, that the user has not provided a use instruction, flow proceeds to step 718, whereupon the document output driver is updated with the current document output driver settings. The document processing request is then updated in accordance with the document output settings at step 724. The updated document processing request is then communicated from the user device 114 to the document processing device 104 via the computer network 102 for processing at step 726.

Returning to step 712, when a determination is made that the user has provided a use instruction, flow proceeds to step 714, whereupon the document output driver accesses the data storage device 116. A determination is then made at step 716 whether the storage location is empty, e.g., the driver determines whether or not there is a registry entry corresponding to document output driver settings. The skilled artisan will appreciate that the driver is capable of ascertaining the status of the storage location on the data storage device 116, as well as the data storage device 122, dependent upon the location of the document output driver settings previously stored. When it is determined at step 716 that the registry entry is empty, flow proceeds to step 718, whereupon the document output driver is updated with the current document output driver settings. Flow then progresses to step 724 and 726, as described in greater detail above.

When it is determined at step 716 that the registry entry, or other suitable storage location on the data storage device 116, the data storage device 122, or the like, is not empty, i.e., document output settings are available, flow proceeds to step 720. At step 720, the document output settings are retrieved from the designated storage location. Thereafter, at step 722, the document output driver is updated with the retrieved document output settings. The document processing request is then updated at step 724 in accordance with the updated document output driver settings. The updated document processing request is then communicated, via the computer network 102, to the document processing device 104 for output thereon.

It will be appreciated by those skilled in the art that the subject application is capable of adaptation for use with a plurality of different document output drivers, each of which is capable of using the stored document output driver settings. Thus, a second document output driver is capable of retrieving the document driver output settings from the data storage device 116 so as to configure the output of an associated electronic document via the second document output driver to the document rendering device 104.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A transferable settings system for multiple document output drivers comprising:
means adapted for accessing an initial document output driver associated with a document processing application and at least one document rendering device;
means adapted for receiving, from an associated user, selected document output settings associated with the initial document output driver;
means adapted for receiving, via the initial document output driver, a save setting instruction from the associated user;
means responsive to a received save setting instruction for storing the selected document output settings to an associated data storage; and
means adapted for selectively retrieving via at least a second document output driver, from the associated data storage, saved document output settings so as to configure an output of an associated electronic document via the second document output driver.

2. The system of claim 1 wherein the at least one document rendering device includes a tangible document output device.

3. The system of claim 2 wherein the selected document output settings are selected from a set comprising orientation, duplex, number of copies, sort parameters, hole punch parameters, stapling parameters, N-up printing parameters, media source selection, output destination selection, accounting information and palette selection.

4. The system of claim 3 wherein the associated data storage is comprised of a registry of an associated operating system.

5. The system of claim 3 wherein the associated data storage is comprised of a non-volatile data storage on a workstation associated with a document output driver.

6. The system of claim 3 wherein the associated data storage is comprised of a networked data storage in data communication with a workstation associated with a document output driver.

7. A transferable settings method for multiple document output drivers comprising the steps of:
accessing an initial document output driver associated with a document processing application and at least one document rendering device;
receiving, from an associated user, selected document output settings associated with the initial document output driver;
receiving, via the initial document output driver, a save setting instruction from the associated user;
responsive to a received save setting instruction, storing the selected document output settings to an associated data storage; and
selectively retrieving via at least a second document output driver, from the associated data storage, saved document output settings so as to configure an output of an associated electronic document via the second document output driver.

8. The method of claim 7 wherein the at least one document rendering device includes a tangible document output device.

9. The method of claim 8 wherein the selected document output settings are selected from a set comprising orientation, duplex, number of copies, sort parameters, hole punch parameters, stapling parameters, N-up printing parameters, media source selection, output destination selection, accounting information and palette selection.

10. The method of claim 9 wherein the selected document output settings are stored in a registry of an associated operating system.

11. The method of claim 9 wherein the selected document output settings are stored in a non-volatile data storage on a workstation associated with a document output driver.

12. The method of claim 9 wherein the selected document output settings are stored in a networked data storage in data communication with a workstation associated with a document output driver.

13. A computer-implemented method for utilization of transferable settings for multiple document output drivers comprising the steps of:
accessing an initial document output driver associated with a document processing application and at least one document rendering device;
receiving, from an associated user, selected document output settings associated with the initial document output driver;
receiving, via the initial document output driver, a save setting instruction from the associated user;
responsive to a received save setting instruction, storing the selected document output settings to an associated data storage; and
selectively retrieving via at least a second document output driver, from the associated data storage, saved document output settings so as to configure an output of an associated electronic document via the second document output driver.

14. The computer-implemented method of claim 13 wherein the at least one document rendering device includes a tangible document output device.

15. The computer-method of claim 14 wherein the selected document output settings are selected from a set comprising orientation, duplex, number of copies, sort parameters, hole punch parameters, stapling parameters, N-up printing parameters, media source selection, output destination selection, accounting information and palette selection.

16. The computer-implemented method of claim 15 wherein the selected document output settings are stored in a registry of an associated operating system.

17. The computer-implemented method of claim 15 wherein the selected document output settings are stored in a non-volatile data storage on a workstation associated with a document output driver.

18. The computer-implemented method of claim 15 wherein the selected document output settings are stored in a networked data storage in data communication with a workstation associated with a document output driver.
